(19) United States
(12) Patent Application Publication
(10) Pub. No.: US 2016/0267936 A1
(43) Pub. Date: Sep. 15, 2016

(54) HOLOGRAM RECORDING AND REPRODUCING APPARATUS

(71) Applicant: HITACHI-LG DATA STORAGE, INC., Tokyo (JP)

(72) Inventors: Kouji FUKUDA, Tokyo (JP); Takashi NAGAI, Tokyo (JP); Shinsuke TAKATSUKA, Tokyo (JP); Akihiro ASHIDA, Tokyo (JP); Hisahiro MIKI, Tokyo (JP)

(73) Assignee: HITACHI-LG DATA STORAGE, INC., Tokyo (JP)

(21) Appl. No.: 15/067,578

(22) Filed: Mar. 11, 2016

(30) Foreign Application Priority Data
Mar. 12, 2015 (JP) 2015-049853

(51) Int. Cl. G11B 7/0065; G11B 17/056

(52) U.S. Cl. CPC G11B 7/0065; G11B 17/056

(57) ABSTRACT

A disk conveyance mechanism for a hologram recording and reproducing apparatus includes a first conveyance mechanism for conveying a disk medium 2 to a position where a spindle motor 4 is situated with the disk medium 2 loaded onto a tray 6, a second conveyance mechanism in which the spindle motor 4 is held and moved in the rotational axis direction of the spindle motor 4 to take out the disk medium 2 from the tray 6 and load the disk medium 2 onto spindle motor 4, a third conveyance mechanism for conveying the disk medium 2 to the position where recording and reproducing are performed by the pickup 1 with the disk medium 2 loaded onto the spindle motor 4. The first and third conveyance mechanisms convey the disk medium 2 in a direction substantially parallel to the surface of the medium.

### CLAIM OF PRIORITY

The present application claims priority from Japanese patent application serial No. JP 2015-049853, filed on Mar. 12, 2015, the content of which is hereby incorporated by reference into this application.

### BACKGROUND OF THE INVENTION

(1) Field of the Invention

The present invention relates to a hologram recording and reproducing apparatus for recording and reproducing data on and from a hologram disk medium.

(2) Description of the Related Art

In a recording and reproducing apparatus using a hologram disk medium without a cartridge, a disk medium is manually loaded in a disk-medium load position inside the apparatus or the disk medium loaded onto a tray is automatically taken therefrom and conveyed to a recording and reproducing position where a pickup is arranged to start a recording and reproducing operation. Japanese Patent Laid-Open No. 2004-279974, for example, discusses that “a movable” tray 14 moves to the upper part of a spindle motor 62 to vertically elevate the spindle motor 62, inserting the rotational axis of the spindle motor 62 into the inner circumferential portion of a recessed portion provided at the center of a medium fixing rotator 63.″

### SUMMARY OF THE INVENTION

An accurate positioning by using a simple conveyance mechanism is required of the hologram recording and reproducing apparatus when a disk medium is automatically conveyed. In the structure discussed in the Japanese Patent Laid-Open No. 2004-279974, the disk medium stored in the movable tray is held by the elevation of the spindle motor and conveyed to the recording and reproducing position opposing the pickup in a one-step operation. However, in a recent hologram apparatus, an optical device forming a pickup has increased in size and complicated in structure to make it difficult to move the tray storing the disk medium to the vicinity of the spindle motor and the pickup because the arrangement of the devices obstructs the movement. For this reason, it is difficult to adopt a simple mechanism for conveying the disk medium from the tray to the recording and reproducing position in the one-step operation discussed in the Japanese Patent Laid-Open No. 2004-279974.

The purpose of the present invention is to cause the hologram recording and reproducing apparatus to surely convey the disk medium to the recording and reproducing position with a simple structure even if the optical device is increased in size and complicated in structure.

The hologram recording and reproducing apparatus according to the present invention includes a pickup which is attached to a fixed frame and irradiates the hologram disk medium with a laser beam to record and reproduce data on and from the hologram disk medium, a spindle motor for holding and rotating the hologram disk medium, a first conveyance mechanism for conveying the hologram disk medium to the position where the spindle motor is situated with the hologram disk medium loaded onto a tray, a second conveyance mechanism in which the spindle motor is held and moved in the rotational axis direction of the spindle motor to take out the hologram disk medium from the tray and load the hologram disk medium onto the spindle motor, a third conveyance mechanism for conveying the hologram disk medium to the position where recording and reproducing are performed by the pickup with the hologram disk medium loaded onto the spindle motor. The first and third conveyance mechanisms convey the hologram disk medium in a direction substantially parallel to the surface of the medium.

According to the present invention, the disk medium can be surely conveyed with a simple structure to the recording and reproducing position even if the optical device is increased in size and complicated in structure, which contributes to improvement in performance of the apparatus.

### BRIEF DESCRIPTION OF THE DRAWINGS

These and other features, objects and advantages of the present invention will become more apparent from the following description when taken in conjunction with the accompanying drawings wherein:

FIG. 1A to FIG. 1D are perspective views showing the structure of a hologram recording and reproducing apparatus and the outline of its operation;

FIG. 2A to FIG. 2B are diagrams showing the structure of a vertical movement mechanism of a disk conveyance unit 3;

FIG. 3A to FIG. 3E are diagrams showing in detail a state where a disk medium is conveyed;

FIG. 4 is a perspective view showing the internal structure of a pickup 1 without the disk loaded;

FIG. 5 is a perspective view showing the internal structure of the pickup 1 with the disk loaded; and

FIG. 6 is a side view showing the internal structure of the pickup 1 with the disk loaded.

### DETAILED DESCRIPTION OF THE EMBODIMENT

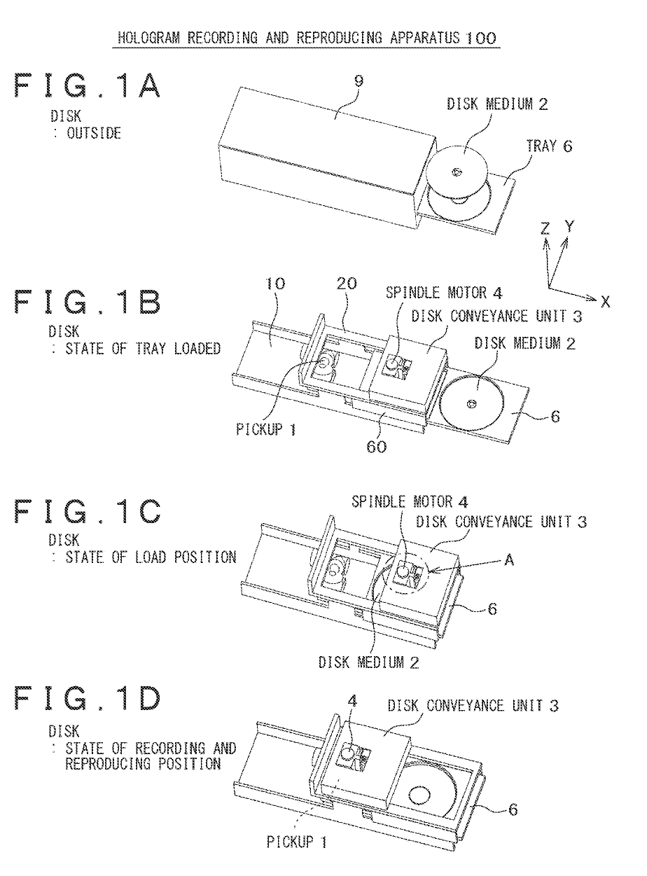

An embodiment of the present invention is described below with reference to the attached drawings. FIG. 1A to FIG. 1D are perspective views showing the structure of a hologram recording and reproducing apparatus 100 and the outline of its operation. FIG. 1A shows the external appearance of the apparatus 100 and FIG. 1B to FIG. 1D show operation states at the time of conveying the disk. In the following, directions are displayed by using X, Y, and Z axes written in the drawings.

FIG. 1A shows the external appearance of the apparatus. A tray 6 is drawn out in the X direction from the opening (the right side in the drawing) of an apparatus housing 9 to the outside of the apparatus. The drawn-out tray 6 is loaded with a hologram disk medium 2 on which recording and reproducing are performed (hereinafter referred to as disk medium).

FIG. 1B shows the internal structure of the apparatus. The disk medium 2 is loaded onto the tray 6 (hereinafter referred to as a state of tray loaded). A pickup 1 for performing hologram recording and reproducing using a laser beam is fixed to an optical frame 10. The structure of the pickup 1 will be described in detail later. A disk conveyance base frame 20 is fixed to the optical frame 10 by a fastening member. A tray conveyance frame 60 is fixed to the disk conveyance base frame 20 by a fastening member.

A disk conveyance unit 3 for holding a spindle motor 4 is attached to the disk conveyance base frame 20 movably in the X direction by a guide member and a driving member (which are not shown). The disk conveyance unit 3 is provided with a vertical movement mechanism for moving the spindle motor 4 in the vertical direction (the Z direction). The structure of the disk conveyance unit 3 will be described in detail later.

The tray 6 loaded with the disk medium 2 is attached to the tray conveyance frame 60 movably in the X direction by a guide member and a driving member (which are not shown). The tray 6 is moved in the X direction (the left direction) in this state to pull the disk medium 2 into the apparatus.

FIG. 1C shows a state where the disk medium 2 is drawn to a position where the spindle motor 4 is situated in the apparatus (hereinafter referred to as a state of load position). In other words, the tray 6 is moved in the X direction to the position where the disk medium 2 opposes the spindle motor 4. Thereafter, the disk conveyance unit 3 drives the vertical movement mechanism to move the held spindle motor 4 in the vertical direction (the Z direction) upward and downward to load the disk medium 2 in the tray 6 onto the spindle motor 4 (attraction operation and lift operation described later). Thereby, the disk medium 2 can be conveyed in the X-direction by the disk conveyance unit 3 while being attracted and held by the spindle motor 4 and can be rotated by the spindle motor 4.

FIG. 1D shows a state where the disk medium 2 is conveyed to a position where the pickup 1 is situated in the apparatus (hereinafter referred to as a state of recording and reproducing position). The disk conveyance unit 3 is moved in the X direction to convey the disk medium 2 loaded onto the spindle motor 4 (attracted and held thereby) to a position where a laser beam is emitted by the pickup 1 (recording and reproducing position). The spindle motor 4 is rotated to allow recording and reproducing to be performed in a desired position on the disk medium 2.

As described above, the conveyance of the disk medium 2 according to the present embodiment is performed by the following three conveyance mechanisms:

### (First Conveyance Mechanism)

The mechanism is such that the disk medium 2 loaded onto the external tray 6 (in FIG. 1B) is conveyed by the tray 6 in the X direction to the position where the spindle motor 4 is situated (in FIG. 1C);

### (Second Conveyance Mechanism)

The mechanism is such that the disk medium 2 loaded onto the tray 6 at the above position (in FIG. 1C) is conveyed by the disk conveyance unit 3 in the Z direction to be loaded onto (attracted by) the spindle motor 4; and

### (Third Conveyance Mechanism)

The mechanism is such that the disk medium 2 loaded onto the spindle motor 4 at the above position (in FIG. 1C) is conveyed by the disk conveyance unit 3 in the X direction to the position where the pickup 1 is situated (in FIG. 1D).

Thus, the disk is conveyed by the three conveyance mechanisms, so that the disk medium can be positioned at a desired position where recording and reproducing are performed without the arrangement of the devices obstructing the conveyance of the tray even if the optical devices of the pickup 1 are increased in size and complicated in structure. This is because the conveyance of the disk medium in the X direction is separated into the conveyance with the disk medium loaded onto the tray (the first conveyance mechanism) and the conveyance with the disk medium taken out from the tray and loaded onto the spindle motor (the third conveyance mechanism), which becomes capable of switchably using either the first conveyance mechanism in the conveyance area where the arrangement of the optical devices does not obstruct the conveyance of the tray or the third conveyance mechanism in the conveyance area where the arrangement of the optical devices obstructs the conveyance of the tray.

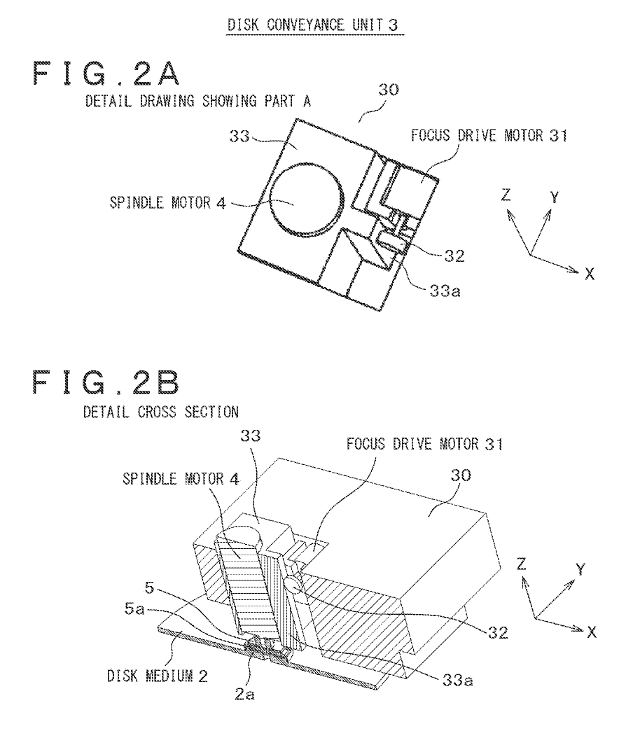

FIG. 2A and FIG. 2B are diagrams showing the structure of the vertical movement mechanism of the disk conveyance unit 3. FIG. 2A is a detail drawing showing the part indicated by an arrow A in FIG. 1C. FIG. 2B shows a detail cross section.

In the disk conveyance unit 3, a spindle motor holder 33 for fixedly holding the spindle motor 4 is attached to a disk conveyance frame 30 for conveying the disk in the X direction. A focus drive motor 31 for moving the disk medium 2 in the vertical direction (the Z direction and used for focus adjustment) is fixed to the disk conveyance frame 30 by a fastening member. The focus drive motor 31 is driven to cause a pinion 32 fixed to the leading edge of the rotation axis of the motor to engage with a rack portion 33a being a part of the spindle motor holder 33, transmitting the power of the focus drive motor 31 thereto. This moves the spindle motor holder 33 in the direction of the rotation axis of the spindle motor (the Z direction) with respect to the disk conveyance frame 30. A cradle 5 provided with a magnet portion 5a is fixed to the rotation axis of the spindle motor 4 to allow the disk medium 2 provided with a metal portion 2a to be attracted.

Thus, the disk conveyance unit 3 integrally incorporates the above conveyance mechanisms 2 and 3 to allow the structure of the apparatus to be simplified.

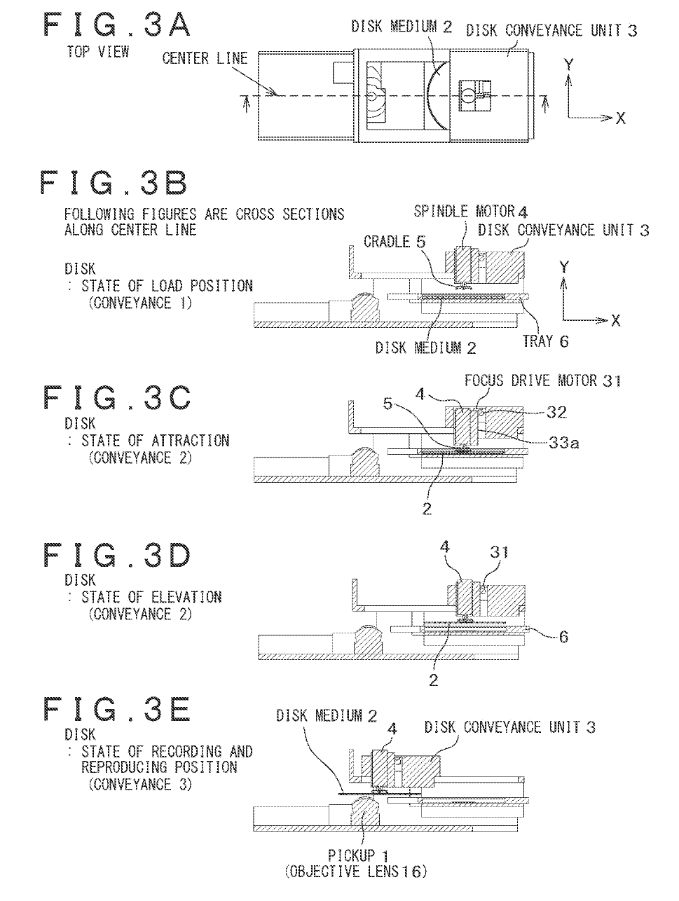

FIG. 3A to FIG. 3E are detail drawings showing a state where the disk medium is conveyed. FIG. 3A is a top view of the apparatus. FIG. 3B to FIG. 3E are cross sections of the apparatus showing a state where the disk medium is conveyed.

FIG. 3A is a top view of the apparatus and shows a state where the disk medium 2 is held by the disk conveyance unit 3 in the apparatus. The following is described by using cross sections along a center line. FIG. 3B shows a state where the tray 6 loaded with the disk medium 2 at an external load position is conveyed in the X direction to the position where the spindle motor 4 is situated in the apparatus (disk load position) (the first conveyance mechanism).

FIG. 3C shows a state where the focus drive motor 31 is driven to lower the spindle motor 4 in the Z direction, bringing the cradle 5 provided at the leading edge of the spindle motor 4 into contact with the disk medium 2 loaded onto the tray 6, which attracts the disk medium 2 by magnetic force (the second conveyance mechanism). This loads the disk medium 2 onto the spindle motor 4. FIG. 3D shows a state where the focus drive motor 31 is driven in the direction opposite to the above (in FIG. 3C) to elevate the spindle motor 4 in the Z direction, taking the disk medium 2 from the tray 6 (the second conveyance mechanism). The height at this point should be lower than the arrangement of optical devices forming the pickup 1.

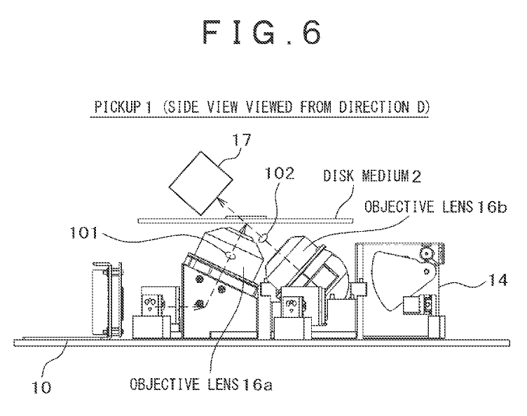

FIG. 3E shows a state where the disk conveyance unit 3 is moved in the X direction to convey the disk medium 2 to a position where an objective lens 16 of the pickup 1 is situated (recording and reproducing position) (the third conveyance mechanism). Incidentally, FIG. 3A to FIG. 3E show only the objective lens 16 as an optical device, however, other than that, there exists a phase conjugate unit opposite to the objective lens 16 between which the disk medium 2 is sandwiched (refer to FIG. 6 described later).

The selection of recording/reproducing positions on the disk medium 2 performs positioning in the disk radius direction by the movement of the disk conveyance unit 3 and positioning in the circumferential direction of the disk by the rotation position of the spindle motor 4. A distance between the pickup 1 (the objective lens 16) and the disk medium 2 (focus distance) is measured by a sensor (not shown) and the focus drive motor 31 is driven to adjust the focus distance to a predetermined value.

As stated above, the conveyance of the disk medium 2 in the X direction is separated into a process in which the disk medium 2 is conveyed to the position where the spindle motor 4 is situated with the disk medium 2 loaded onto the tray 6 (the first conveyance mechanism) and a process in which the disk medium 2 is conveyed to the position where the pickup 1 is situated with the disk medium 2 taken out from the tray 6 and loaded onto the spindle motor 4 (the third conveyance mechanism), so that the arrangement of the optical devices of the pickup 1 does not obstruct the conveyance of the tray 6. The second conveyance mechanism in which the disk medium 2 is taken out from the tray 6 and loaded on the spindle motor 4 is constituted using the focus drive motor 31 for adjusting focus to eliminate the need for a dedicated driving source, which makes it effective to simplify the constitution.

In the above description, the focus drive motor 31 is used as a driving source for moving the spindle motor 4 (that is, the disk medium 2) in the vertical direction (the Z direction), however, the driving source is not limited to that, but a tilt drive motor for adjusting the tilt of the disk medium 2, for example, may be used.

The following describes the recording and reproducing operation performed by the hologram recording and reproducing apparatus according to the present embodiment. The pickup 1 irradiates the disk medium 2 with a laser beam to record and reproduce data on and from the disk medium 2.

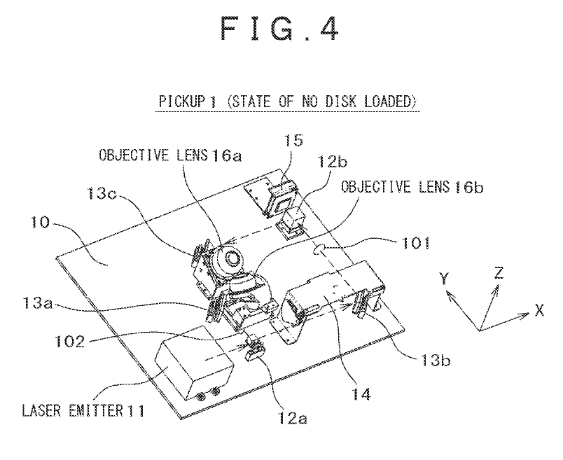

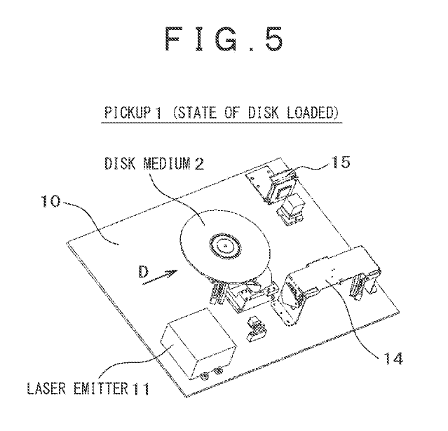

FIG. 4 to FIG. 6 are diagrams showing the internal structure of the pickup 1. FIG. 4 is a perspective view showing a state where the disk medium is not loaded. FIG. 5 is a perspective view showing a state where the disk medium is loaded. FIG. 6 is the side view of FIG. 5.

In FIG. 4, the pickup 1 is fixed to the optical frame 10 and optical devices such as a laser emitter 11, spectroscopes 12a and 12b, mirrors 13a, 13b, and 13c, a shutter mechanism unit 14, an optical modulator 15, and objective lenses 16a and 16b are arranged at positions where the devices are shown.

A laser beam emitted by the laser emitter 11 is branched into two systems of optical paths 101 and 102 by the spectroscope 12a. The optical path 101 transmits a signal light in recording and the optical path 102 transmits a reference light in both recording and reproducing. The signal light is emitted from the objective lens 16a and passes through the shutter mechanism unit 14 for controlling an emission time, the mirror 13b, the spectroscope 12b, the optical modulator 15 for modulating the laser beam by recording data, the spectroscope 12b, and the mirror 13c. The reference light is emitted from the objective lens 16b and passes through the mirror 13a. At an extension optical path area for the optical path 102 through which the reference light emitted from the objective lens 16b passes, there is arranged a phase conjugate unit 17 for emitting return light along the same trajectory as that of the optical path 102 (refer to FIG. 6).

FIG. 5 shows a state where the pickup 1 shown in FIG. 4 is loaded with the disk medium 2. The phase conjugate unit 17 is omitted in FIG. 5. FIG. 6 is a side view of FIG. 5 when viewing the pickup 1 from a direction indicated by an arrow D. The disk medium 2 is conveyed by the disk conveyance unit 3 and held in the space sandwiched between the objective lenses 16a and 16b and the phase conjugate unit 17 in the pickup 1.

At the time of recording, the hologram disk medium 2 is irradiated with the signal light which is emitted from the objective lens 16a of the pickup 1 and passes through the optical path 101 and the reference light which is emitted from the objective lens 16b and passes through the optical path 102 to record the data by the interference pattern (hologram) generated at that time. At the time of reproducing, the shutter mechanism unit 14 is operated to shut off the signal light passing through the optical path 101 and the disk medium 2 is irradiated only with the reference light passing through the optical path 102 to reproduce the data (hologram) recorded on the disk medium 2 by the return light (conjugate light) generated by the phase conjugate unit 17, detecting reproducing light via the objective lens 16a.

According to the hologram recording and reproducing apparatus of the present embodiment, the disk is conveyed by the three conveyance mechanisms, so that the disk medium can be surely positioned at a desired position where recording and reproducing are performed without the arrangement of the devices obstructing the conveyance of the tray, even if the optical devices of the pickup 1 are increased in size and complicated in structure, as shown in FIG. 4 to FIG. 6, which contributes to improvement in performance of the hologram recording and reproducing apparatus.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A hologram recording and reproducing apparatus for recording and reproducing data on and from a hologram disk medium comprising:
a pickup which is attached to a fixed frame and irradiates the hologram disk medium with a laser beam to record and reproduce data on and from the hologram disk medium;
a spindle motor for holding and rotating the hologram disk medium;
a first conveyance mechanism for conveying the hologram disk medium to the position where the spindle motor is situated with the hologram disk medium loaded onto a tray;
a second conveyance mechanism in which the spindle motor is held and moved in the rotational axis direction of the spindle motor to take out the hologram disk medium from the tray and load the hologram disk medium onto the spindle motor; and
a third conveyance mechanism for conveying the hologram disk medium while loading the hologram disk medium onto the spindle motor to the position where recording and reproducing are performed by the pickup, wherein
the first and third conveyance mechanisms convey the hologram disk medium in a direction substantially parallel to the surface of the medium.

2. The hologram recording and reproducing apparatus according to claim 1, further comprising a focus drive motor for adjusting a focus distance between the pickup and the hologram disk medium in the position where recording and reproducing are performed, the focus drive motor being used as a driving source of the second conveyance mechanism.

3. The hologram recording and reproducing apparatus according to claim 2, wherein
the second and third conveyance mechanisms are incorporated in a common disk conveyance unit.
